(19) United States
(12) Patent Application Publication
(10) Pub. No.: US 2024/0330282 A1
(43) Pub. Date: Oct. 3, 2024

(54) ARTIFICIAL INTELLIGENCE AND MACHINE LEARNING DRIVEN NETWORK CONTROLLED COMPUTER AUTOMATED SYSTEMS AND METHODS FOR AGGREGATION, ANALYSIS AND CONTROL

(71) Applicant: Taascom Inc., San Jose, CA (US)

(72) Inventors: Ranga Raj, Bangalore (IN); Sanjiv Shrikant Shet, Bangolar (IN)

(73) Assignee: Taascom Inc., San Jose, CA (US)

(21) Appl. No.: 18/349,987

(22) Filed: Jul. 11, 2023

(30) Foreign Application Priority Data
Mar. 27, 2023 (IN) 202341021811

(51) Int. Cl. G06F 16/242; G06F 16/28; G16Y 40/10; G16Y 40/30

(52) U.S. Cl. CPC G06F 16/244; G06F 16/283; G16Y 40/10; G16Y 40/30

(57) ABSTRACT

Embodiments disclosed include computer automated systems and methods to aggregate a plurality of data types from a corresponding plurality of data sources in a time synchronized multi-dimensional, time series fashion, analyze the aggregated plurality of data types from the corresponding plurality of data sources, and output actionable data based on the analyzed aggregated plurality of data types, and based on the output actionable data, control some or all of the plurality of data sources. Embodiments disclosed include, a control engine, the trigger by instructions from an analytics engine, configured to initiate a control action in at least one of a facility, a single or plurality of devices, a point of sale system and a digital signage equipment, at least one of a service, a counter, a promotion, a quality check, an update and a device orchestration.

### CROSS REFERENCE TO RELATED APPLICATIONS

The present applications bears reference to U.S. application Ser. No. 15/151,739 filed May 11 2016, entitled “COMPUTER NETWORK CONTROLLED DATA ORCHESTRATION SYSTEM AND METHOD FOR DATA AGGREGATION, NORMALIZATION, FOR PRESENTATION, ANALYSIS AND ACTION/DECISION MAKING” the contents of which are incorporated by reference in their entirety.

### BACKGROUND

### Field

This application relates to artificial intelligence and machine learning driven platforms for controlling systems, devices and actionable data dissemination based on multi-dimensional, time synchronized aggregation and analysis from and to a plurality of devices and device types, a plurality of data and data types, a plurality of machines and machine types and a plurality of applications in a wired or wireless networked framework.

### Related Art

As computerization and networked devices capable of communicating with each other have become all, this has resulted in a vast amount and number of disparate data sources. Data sources include sensors, devices and device types, mobile devices, machines, applications, data and data types, etc. Additionally, data sources comprise multiple vendors, varied models of the sensors, devices, mobile devices, machines and applications. Yet additionally, the devices are run by varied/different Operating Systems (OS), protocols etc. Further compounding the problem is a lack of standardization, wherein multiple vendors, models, operating systems, protocols, etc. make it impossible for seamless communication across device models and brands. Addressing this challenge requires three key steps—1. Data aggregation and normalization, 2. Data analysis based on events, conditions, and trends across disparate data sources, and 3. Time synchronized control based on the aggregation and analysis, often as a return path or closed loop back to the machines/sensors and or other devices/applications.

However, today's systems offer sequential steps that are time consuming, wherein by the time a decision is taken, control actions may be erroneous because the data and device conditions may have changed leading to wrong decisions. Compounding the lack of synchronization, solutions available are isolated solutions and tend to be silos of a single context, vendor, device and type, machine type, application, etc. and lack adequate artificial intelligence and machine learning capabilities.

There remains a need for automated, real-time, artificial intelligence and machine learning driven decision making and control, based on aggregation and analysis from a plurality of device and data classes. There remains a further need in such an analysis for a correlation capability across the multiple sources. There also remains an additional need to perform such analysis, correlation, and decision making, in real-time, in an automated, multi-dimensional, time synchronized fashion. Embodiments disclosed address the above challenges.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer automated system comprising a multi-dimensional database. The computer automated system further includes a data aggregation engine configured to aggregate a plurality of data types from a corresponding plurality of data sources, in communication with the multi-dimensional, time synchronized time series database. Additionally, the system comprises a data analytics engine configured to analyze the aggregated plurality of data types from the corresponding plurality of data sources, and stored in the multi-dimensional, time synchronized time series database. Yet additionally, the system comprises a control engine, triggered by feedback from the analytics engine, configured to output actionable data based on the analyzed aggregated plurality of data types, and to control some or all of the plurality of data sources and data end points. Other embodiments of this aspect include corresponding computer systems, apparatus, and computer programs recorded on one or more computer storage devices, each configured to perform the actions of the methods.

One general aspect includes a computer implemented method comprising, in a data aggregation engine in communication with a multi-dimensional, time synchronized time series database, aggregating a plurality of data types from a corresponding plurality of data sources, and storing the aggregated plurality of data types in the multi-dimensional, time synchronized time series database. The computer implemented method further includes, in a data analytics engine, analyzing the aggregated plurality of data types from the corresponding plurality of data sources, and stored in the multi-dimensional, time synchronized time series database. Yet additionally, the computer implemented method comprises, in a control engine triggered by feedback from the analytics engine, and based on the analyzed aggregated plurality of data types, controlling some or all of the plurality of data sources and data end points. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 illustrates the computer automated system according to an embodiment.

FIG. 2 illustrates the computer implemented method according to an embodiment.

FIG. 3 illustrates the computer implemented method according to an additional embodiment.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. In other instances, well-known features have not been described in detail to avoid obscuring the invention.

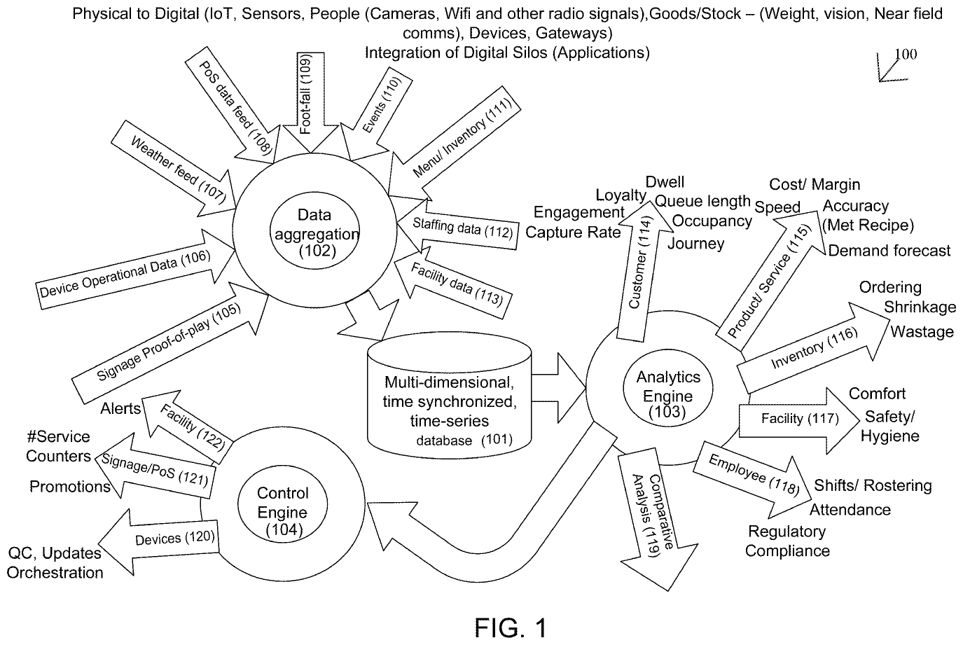

FIG. 1 illustrates the computer automated system according to an embodiment. The computer automated system 100 comprises Multi-Dimensional time synchronized time series database 101, Data Aggregation Engine 102, Data Analytics Engine 103, and Control Engine 104. According to an embodiment Data Aggregation Engine 102 is configured to aggregate a plurality of data types from a corresponding plurality of data sources, and store the aggregated data in the multi-dimensional time synchronized time series database. According to one embodiment data is received at a web-endpoint asynchronously. Alternatively, data is polled using a web Application Programming Interface (API) periodically, i.e. polling data is synchronous, where the periodicity preferably is reconfigurable. Additionally, synchronous polling of data causes delivery of the polled data in preconfigured but reconfigurable intervals of time. And data received over the web endpoint causes data delivery immediately, in real-time. According to an embodiment, the plurality of data sources comprise a corresponding plurality of device classes comprising at least one of internet of things (IOT) sensors, cameras, wi-fi, radio signals, machine vision, near field communication devices, and gateways. Additionally and preferably, each of the plurality of device classes are configured to capture a single or plurality of data classes embedded in a corresponding single or plurality of software applications. And the plurality of data sources comprise at least one of digital signage proof of play 103, device operational data 106, weather feed data 107, point of sale (POS) data feeds 108, human foot fall data 109, event data 110, menu and inventory data 111, staffing data 112 and facility data 113.

According to an embodiment, the data analytics engine 103, in analyzing the aggregated plurality of data types from the corresponding plurality of data sources is further configured to: analyze data from at least one of internet of things (IOT) sensors, cameras, wi-fi, radio signals, machine vision, near field communication devices, and gateways. And further, the data analytics engine, in analyzing the aggregated plurality of data types from the corresponding plurality of data sources is configured to analyze the data aggregated from the at least one of digital signage proof of play, device operations, weather feeds, point of sale (POS) devices, human foot falls, events, menus, inventory, staffing and facilities data.

According to a preferred embodiment, the data analytics engine 103 is further configured to analyze a customer data 114 which comprises analyzing the customer capture rate, the customer engagement, the customer loyalty, the customer dwell, the customer real or virtual queue length, the customer occupancy and the customer journey. The analytics engine can analyze a product or service demand 115 forecast, cost and margin, delivery speed, and fulfilment accuracy. Further, the analytics engine can analyze an inventory demand 116 forecast, order, shrinkage and wastage. Yet additionally, and preferably, the analytics engine can estimate a facility 117 safety score, hygiene, and comfort. According to a preferred embodiment, the analytics engine is configured to estimate an employee 118 shift and roster, attendance, and regulatory compliance and perform a comparative analysis 119.

According to an embodiment, the control engine 104 is further configured to, based on the trigger from the analytics engine 103, initiate in at least one of a facility 122, a single or plurality of devices, a point of sale system and a digital signage equipment 121, at least one of a service, a counter, a promotion, a quality check, an update and a device orchestration.

According to an embodiment, the data aggregation engine 102 is further configured to aggregate the plurality of data types from the corresponding plurality of data sources via a web end point, or/and poll the aggregated data using a web API at a pre-configured frequency. The data aggregation engine is further configured to handle and route the aggregated data into streams and batches, and to store the data in source format on a storage block comprised in the multi-dimensional, time synchronized time series database. Preferably, the system is configured to separate the stored data into measurements and attributes, and additionally to record and track attributes in a data warehouse. According to an embodiment, the recorded measurements are time synchronized with the determined attributes. Subsequently, the data is queried, and based on a response, the data is re-aggregated with respect to the attributes. Preferably, the data analytics engine is further configured to perform real time analysis of streamed data. And based on the real time analysis of the streamed data, provide feedback to trigger the control engine. Additionally and preferably, the analytics engine comprises a compute application and domain specific metrics to trigger a machine learning engine to predict, correct and calibrate feedback and control. And based on the calibrated feedback and control, the analytics engine provides feedback to trigger the control engine.

The computer automated system wherein the measurements comprise at least one of but not restricted to, sales revenue, SKU sales, customer demography, current weather measurements (temperature, humidity, rainfall, snow, etc.), signage proof-of-play, device operational metrics, foot-fall, event occurrences, staff attendance, and facility sensor measurements. The attributes comprise at least one of but not restricted to timestamp, location, weather, device ID, menu ID, inventory ID, and floorplan.

The computer automated system wherein the computer automated system is further configured to read device data over an IoT channel supporting multiple protocols such as MQTT, HTTPS, CoAP, AMPQ, and WebSocket, and to add metadata using configuration of user interfaces and aggregate enterprise data over an enterprise service bus.

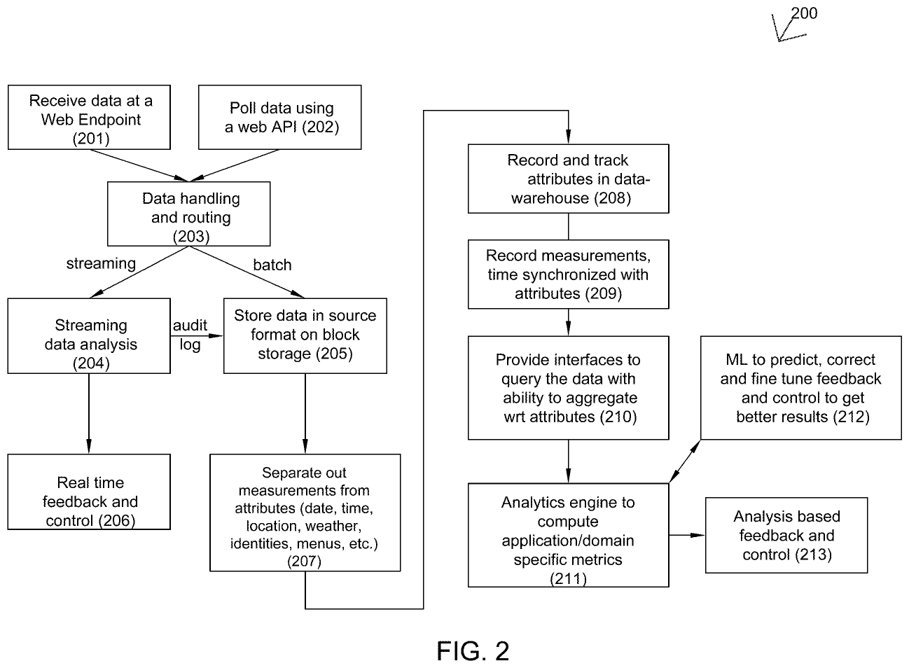

FIG. 2 illustrates the computer implemented method according to an embodiment. According to an embodiment of the computer implemented method, the method comprises time synchronizing a multi-dimensional database, and aggregating a plurality of data types from a corresponding plurality of data sources and storing the aggregated plurality of data types in the multi-dimensional database. According to a preferred embodiment, the method further comprises analyzing the aggregated plurality of data types from the corresponding plurality of data sources stored in the multi-dimensional, time synchronized database, and outputting actionable data triggered by the analysis of the aggregated plurality of data types and controlling some or all of the plurality of data sources.

FIG. 2 depicts aggregating data asynchronously by receiving data at web point 201 or/and polling data using a web API 202, wherein polled data is synchronous i.e. polled periodically. Synchronous data is delivered at periodic intervals, wherein the periodicity is reconfigurable while asynchronous data is delivered immediately, in real-time. Step 203 entails data handling and routing wherein data is processed as a batch at reconfigurable pre-configured intervals and output for analytical purposes 204. Additionally and alternatively, data is streamed for streaming data analysis 204 wherein the streaming data analysis can preferably be performed in real-time. Step 205 includes storing data in source format on block storage 205 wherein data is preferably processed in a single or plurality of batches. Step 206 entails real-time feedback and control based on streaming data analysis 204. Step 207 includes distinguishing measurements from attributes and separating out the distinguished measurements and attributes. Attributes include date, time, weather, location, identities, menus, etc.). Additionally, identities can be device identities or/and data source identities and time invariant or slowly changing attributes. Step 208 includes recording and tracking attributes in a data warehouse. And step 209 includes recording measurements, preferably time synchronized with the recorded attributes. Step 210 includes systems and methods to enable automated or manual querying of the data and are configured to enable aggregation of the queried data with respect to their attributes. Step 211 includes computing application and domain specific metrics by an analytics engine in communication with a machine learning engine 212 configured to predict, correct and fine tune feedback and control to get accurate estimates, and thereby better results. Step 213 entails control, based on a trigger from the analytics engine, to initiate in at least one of a facility, a single or plurality of devices, a point of sale system and a digital signage equipment, at least one of a service, a counter, a promotion, a quality check, an update and a device orchestration.

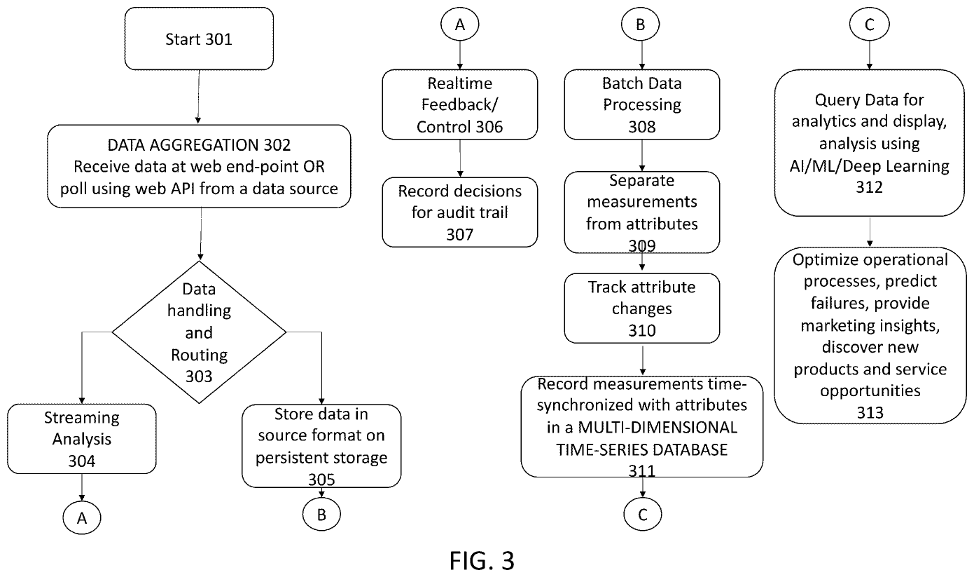

FIG. 3 illustrates the computer implemented method according to an additional embodiment. The computer implemented method 300 begins 301 with a data aggregation step 302 wherein data is aggregated either by receiving data at a web end-point or by polling data from a data source using a web API. Data can be polled synchronously or asynchronously. Data handling and routing 303 happens selectively, wherein data is either streamed for analysis 304 or stored in source format 305 on persistent storage. Streaming data analysis 304 is followed by real-time feedback and/or control 306. Step 307 entails creating a repository of an audit trail comprising recorded decisions in feedback and control. Alternatively, when data is stored in source format 305, subsequently a batch processing step 308 precedes step 309 wherein measurement data is separated from attribute data. Step 310 entails tracking changes in data attributes and subsequently time synchronization of measurements with attributes 311 is recorded in a multi-dimensional time series database. In step 312, data is queried, and queried data is analyzed using Artificial Intelligence (AI), Machine Learning (ML) or/and Deep Learning (DL) and subsequently displayed on a user interface. The analysis 312 enables step 313 comprising optimization of the operational process, prediction of failures, market insights, and discovery.

According to an embodiment, a computer automated system comprises a processing unit coupled to a memory element and having instructions encoded thereon. The encoded instructions when implemented by the processing unit cause the computer automated system to collect primary data from a plurality of primary sensor data streams comprised in a corresponding plurality of primary data sources. Preferably and additionally, the computer automated system is caused to collect secondary data from a plurality of secondary sensor data streams comprised in a corresponding plurality of secondary data sources. According to an embodiment of the computer automated system, an analytics engine comprised in a controller module is configured to analyze the collected primary and secondary data. Additionally a synchronization engine comprised in the controller module is configured to synchronize the collected primary data, and preferably synchronize the collected secondary data. Yet additionally a machine learning engine comprised in the controller module is configured to, based on the collected synchronized primary and secondary data, calibrate the computer automated system. Preferably, an artificial intelligence engine also comprised in the controller module is configured to calibrate the machine learning engine. An alternative embodiment includes a fault detection engine comprised in the controller module configured to detect zero or more anomalies in the primary data sources, the secondary data sources, and the controller module. Embodiments disclosed include repositories and databases that may be time synchronized and multi-dimensional and are preferably configured to store real-time and historical data collected via the primary and secondary data streams. Alternatively and additionally storage can be on a device cloud operatively coupled to the primary and secondary data sources and connected to the controller module via a network. Additional embodiments include a configuration that enables communication of a need fulfilment instruction via the network to a responder module operatively coupled to the controller module and comprising a physical support engine, an inventory engine, a warehouse engine, and a supply engine.

According to a preferred embodiment, the analytics engine is further caused to process primary and secondary historical data to analyze a past performance. And the synchronization engine is further caused to synchronize the primary and secondary data from the plurality of primary and secondary data streams with the processed primary and secondary historical data. Additionally and preferably the machine learning engine is further caused to calibrate the computer automated system based on the synchronized data. Further, the artificial intelligence engine is further caused to calibrate the machine learning engine, and the fault detection engine is further caused to, based on the synchronized data, detect zero or more anomalies in one or more of the plurality of primary and secondary data sources. According to an embodiment, the computer automated system is caused to, based on the detected anomalies, trigger the delivery of the detected anomaly to an automated network operations center (NOC) via the physical support engine, and match the determined anomaly to a historical anomaly by the network operations center. Yet additionally, based on the match, an action is determined, and based on the determined action, a virtual module from a plurality of virtual modules is assigned. Preferably, the assigned virtual module is caused to trigger the performance of the determined action.

According to an embodiment of the computer automated system the primary data sources comprise at least one of PLC, CNC, Robotic, generic sensors and vision capture devices. Additionally and preferably, the machine learning engine is further configured to run machine learning applications and generate applications based on analyzed primary and secondary data capture.

An embodiment includes a computer implemented method comprising collecting data from a plurality of data sources. According to one embodiment, primary data is collected from a plurality of primary sensor data streams comprised in a corresponding plurality of primary data sources. Subsequently or simultaneously secondary data is collected from a plurality of secondary sensor data streams comprised in a corresponding plurality of secondary data sources. An embodiment includes analyzing the collected primary and secondary data. An additional embodiment includes synchronizing the collected primary and secondary data. A preferred embodiment includes a pre-configured and reconfigurable machine learning engine which, based on the collected synchronized or/and analyzed primary and secondary data can be triggered for calibrating the computer automated system. An additional preferred embodiment comprises an artificial intelligence engine configured for calibrating the machine learning engine. An embodiment includes a fault detection system for detecting zero or more anomalies in the primary data sources, the secondary data sources, and a controller module. Repositories and databases that may be multi-dimensional and time synchronized are used for storing real-time and historical data collected via the primary and secondary data streams. Alternatively and additionally, storage on a device cloud operatively coupled to the primary and secondary data sources and connected to the controller module via a network is used. A preferred embodiment of the method includes communicating a need fulfilment instruction via the network to a responder module operatively coupled to the controller module and comprising a physical support engine, an inventory engine, a warehouse engine, and a supply engine.

Embodiments disclosed enable aggregation and synchronization of data from data sources of multiple vendors, varied models of the sensors, devices, mobile devices, machines and applications. Yet additionally, embodiments disclosed enable aggregation and synchronization of data from devices run by varied/different Operating Systems (OS), protocols etc. Embodiments disclosed enable standardization, wherein multiple vendors, models, operating systems, protocols, etc. making it possible for seamless communication across device models and brands.

Embodiments disclosed enable. data aggregation and normalization, data analysis based on events, conditions, and trends across disparate data sources, and time synchronized control based on the aggregation and analysis, often as a return path or closed loop back to the machines/sensors and or other devices/applications.

Embodiments of systems and methods disclosed enable a plurality of aggregation, standardization and analytical actions simultaneously, often in real-time leading to accurate estimates in parallel and thus control actions that are timely and relevant.

Embodiments disclosed enable automated, real-time, artificial intelligence and machine learning driven decision making and control, based on aggregation and analysis from a plurality of device and data classes. Additionally, embodiments disclosed enable a correlation capability across the multiple sources. Yet additionally, embodiments disclosed enable such analysis, correlation, and decision making, in real-time, in an automated, multi-dimensional, time synchronized fashion.

Since various possible embodiments might be made of the above invention, and since various changes might be made in the embodiments above set forth, it is to be understood that all matter herein described or shown in the accompanying drawings is to be interpreted as illustrative and not to be considered in a limiting sense. Thus, it will be understood by those skilled in the art of computer automated artificial intelligence and machine learning systems and methods, and more particularly, artificial intelligence and machine learning driven network controlled computer automated systems and methods for aggregation, analysis and control that although the preferred and alternate embodiments have been shown and described in accordance with the Patent Statutes, the invention is not limited thereto or thereby.

The figures illustrate the architecture, functionality, and operation of possible implementations of systems, methods and computer program products according to various embodiments of the present invention. It should also be noted that, in some alternative implementations, the functions noted/illustrated may occur out of the order noted in the figures. For example, two blocks shown in succession may, in fact, be executed concurrently, or the blocks may sometimes be executed in the reverse order, depending upon the functionality involved.

The terminology used herein is for the purpose of describing embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-accessible format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any program nomenclature that follows is used merely for convenience, and thus the invention should not be limited to use solely in any specific application identified and/or implied by such nomenclature.

The present invention and some of its advantages have been described in detail for some embodiments. It should be understood that although the system and process are described with reference to artificial intelligence and machine learning driven time-synchronized computer automated systems and methods, the systems and methods are highly reconfigurable, and may be used in other contexts and systems/methods as well. Portions of the embodiment may be used to support systems and methods for other types of data communication systems, updates and even repair of machines by other machines. It should also be understood that various changes, substitutions and alterations can be made herein without departing from the spirit and scope of the invention as defined by the appended claims. An embodiment of the invention may achieve multiple objectives, but not every embodiment falling within the scope of the attached claims will achieve every objective. Moreover, the scope of the present application is not intended to be limited to the embodiments of the process, machine, manufacture, composition of matter, means, methods and steps described in the specification. A person having ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

1. A computer automated system comprising at least one processing unit coupled to a memory element and having instructions encoded thereon, which instructions cause the computer automated system to:
time synchronize a multi-dimensional database;
aggregate, via a data aggregation engine, a plurality of data types from a corresponding plurality of data sources, and store the aggregated data in a time synchronized manner in a multi-dimensional database;
analyze, via a data analytics engine, the aggregated plurality of data types from the corresponding plurality of data sources, and stored-time synchronized in the multi-dimensional database; and
output, via a control engine, actionable data based on the analyzed aggregated plurality of data types, and based on the output actionable data, control some or all of the plurality of data sources.

2. The computer automated system of claim 1 wherein: the data aggregation engine, in aggregating the plurality of data types from the corresponding plurality of data sources, wherein the plurality of data sources comprise a corresponding plurality of device classes comprising at least one of internet of things (IOT) sensors, cameras, wi-fi, radio signals, machine vision, near field communication devices, and gateways.

3. The computer automated system of claim 1 wherein: the plurality of data sources comprise at least one of digital signage proof of play, device operational data, weather feed data, point of sale (POS) data, human foot fall data, event data, menu data, inventory data, staffing data and facility data.

4. The computer automated system of claim 1 wherein: the data analytics engine, in analyzing the aggregated plurality of data types from the corresponding plurality of data sources is further configured to: analyze data from at least one of internet of things (IOT) sensors, cameras, wi-fi, radio signals, machine vision, near field communication devices, and gateways.

5. The computer automated system of claim 1 wherein: the data analytics engine, in analyzing the aggregated plurality of data types from the corresponding plurality of data sources is further configured to: analyze data from at least one of digital signage proof of play, device operations, weather feeds, point of sale (POS) devices, human foot falls, events, menus, inventory, staffing and facilities data.

6. The computer automated system of claim 1 wherein the data analytics engine is further configured to analyze: a customer data which comprises analyzing the customer capture rate, the customer engagement, the customer loyalty, the customer dwell, the customer real or virtual queue length, the customer occupancy and the customer journey; a product or service demand forecast, cost and margin, delivery speed, and fulfilment accuracy; an inventory demand forecast, order, shrinkage and wastage; a facility safety score, hygiene, and comfort; an employee shift and roster, attendance, and regulatory compliance; and a comparative analysis.

7. The computer automated system of claim 1 wherein the control engine is further configured to: based on the trigger from the analytics engine, initiate in at least one of a facility, a single or plurality of devices, a point of sale system and a digital signage equipment, at least one of a service, a counter, a promotion, a quality check, an update and a device orchestration.

8. The computer automated system of claim 1 wherein: the data aggregation engine is further configured to: aggregate the plurality of data types from the corresponding plurality of data sources via a web endpoint; poll the aggregated data using a web API at a pre-configured frequency; handle and route the aggregated data into streams and batches; store the data in source format on a storage block comprised in the multi-dimensional, time synchronized time series database; separate the stored data into measurements and attributes; record and track attributes in a data warehouse; record measurements time synchronized with attributes; query data for re-aggregating the queried data with respect to the attributes; he data analytics engine is further configured to: perform real time analysis of streamed data; based on the real time analysis of the streamed data, provide feedback to trigger the control engine; compute application and domain specific metrics and trigger a machine learning engine to predict, correct and calibrate feedback and control; and based on the calibrated feedback and control, provide feedback to trigger the control engine.

9. The computer automated system of claim 1 wherein the computer automated system is further configured to: read device data over an IoT channel supporting multiple protocols such as MQTT, HTTPS, CoAP, AMPQ, and WebSocket; add metadata using configuration user interfaces; and aggregate enterprise data over an enterprise service bus.

10. A computer implemented method comprising:
time synchronizing a multi-dimensional database comprised in a time series database;
aggregating, via a data aggregation engine, a plurality of data types from a corresponding plurality of data sources and storing the aggregated plurality of data types in a time synchronized manner in a multi-dimensional database;
analyzing, via a data analytics engine, the aggregated plurality of data types from the corresponding plurality of data sources stored in the multi-dimensional, time synchronized database; and
outputting, via a control engine, actionable data triggered by the analysis of the aggregated plurality of data types and controlling some or all of the plurality of data sources.

11. The computer implemented method of claim 10 further comprising: in the aggregation engine, aggregating the data via at least one of internet of things (IOT) sensors, cameras, wi-fi, radio signals, machine vision, near field communication devices, and gateways.

12. The computer implemented method of claim 10 wherein: aggregating the data from the plurality of data sources comprises aggregating at least one of digital signage proof of play data, device operational data, weather feed data, point of sale (POS) data, human foot fall data, event data, menu data, inventory data, staffing data and facility data.

13. The computer implemented method of claim 10 wherein: analyzing the aggregated plurality of data types from the corresponding plurality of data sources further comprises analyzing data from at least one of internet of things (IOT) sensors, cameras, wi-fi, radio signals, machine vision, near field communication devices, and gateways.

14. The computer implemented method of claim 10 wherein: in the analytics engine, analyzing the aggregated plurality of data types from the corresponding plurality of data sources further comprises analyzing data from at least one of digital signage proof of play, device operations, weather feeds, point of sale (POS) devices, human foot falls, events, menus, inventory, staffing and facilities data.

15. The computer implemented method of claim 10 further comprising, in the data analytics engine, analyzing: a customer data which comprises analyzing the customer capture rate, the customer engagement, the customer loyalty, the customer dwell, the customer real or virtual queue length, the customer occupancy and the customer journey; a product or service demand forecast, cost and margin, delivery speed, and fulfilment accuracy; an inventory demand forecast, order, shrinkage and wastage; a facility safety score, hygiene, and comfort; an employee shift and roster, attendance, and regulatory compliance; and a comparative analysis.

16. The computer implemented method of claim 10 further comprising, in the control engine: based on the trigger from the analytics engine, initiating in at least one of a facility, a single or plurality of devices, a point of sale system and a digital signage equipment, at least one of a service, a counter, a promotion, a quality check, an update and a device orchestration.

17. The computer implemented method of claim 10 further comprising: in the data aggregation engine, aggregating the plurality of data types from the corresponding plurality of data sources via a web endpoint; polling the aggregated data using a web API at a pre-configured frequency; handling and routing the aggregated data into streams and batches; storing the data in source format on a storage block comprised in the multi-dimensional, time synchronized time series database; separating the stored data into measurements and attributes; recording and tracking attributes in a data warehouse; recording measurements time synchronized with attributes; querying data for re-aggregating the queried data with respect to the attributes; in the data analytics engine, performing real time analysis of streamed data; based on the real time analysis of the streamed data, providing feedback to trigger the control engine; computing application and domain specific metrics and triggering a machine learning engine to predict, correct and calibrate feedback and control; and based on the calibrated feedback and control, providing feedback to trigger the control engine.

18. The computer implemented method of claim 17 further comprising: reading device data over an IoT channel supporting multiple protocols such as MQTT, HTTPS, CoAP, AMPQ, and WebSocket; adding metadata using configuration user interfaces; and aggregating enterprise data over an enterprise service bus.

19. A computer automated system comprising:
a plurality of primary sensor data streams comprised in a corresponding plurality of primary data sources;
a plurality of secondary sensor data streams comprised in a corresponding plurality of secondary data sources;
a controller module comprising:
an analytics engine;
a synchronization engine;
a machine learning engine;
an artificial intelligence engine; and
a fault detection engine;
wherein the controller module is connected via a network to a device cloud operatively coupled to the primary and secondary data sources and comprises a repository for storing real-time and historical data collected via the primary and secondary data streams; and
a responder module operatively connected to the controller module and comprising:
a physical support engine;
an inventory engine;
a warehouse engine; and
a supply engine.

20. The computer automated system of claim 19 wherein:
the analytics engine is further caused to process primary and secondary historical data to analyze a past performance;
the synchronization engine is further caused to synchronize the primary and secondary data from the plurality of primary and secondary data streams with the processed primary and secondary historical data;
the machine learning engine is further caused to calibrate the computer automated system based on the synchronized data;
the artificial intelligence engine is further caused to calibrate the machine learning engine;
the fault detection engine is further caused to, based on the synchronized data, detect zero or more anomalies in one or more of the plurality of primary and secondary data sources;
based on the detected anomalies, trigger the delivery of the detected anomaly to an automated network operations center (NOC) via the physical support engine;
match the determined anomaly to a historical anomaly by the network operations center;
based on the match, determine an action;
based on the determined action, assign a virtual module from a plurality of virtual modules; and
trigger the performance of the determined action by the assigned virtual module.
